(19) United States
(12) Patent Application Publication
(10) Pub. No.: US 2015/0302111 A1
(43) Pub. Date: Oct. 22, 2015

(54) Method and Apparatus for Constructing File System in Key-Value Storage System, and Electronic Device

(71) Applicant: Huawei Technologies Co., Ltd., Shenzhen (CN)

(72) Inventors: Yinliang Yue, Beijing (CN); Jin Xiong, Beijing (CN); Lixin Zhang, Beijing (CN); Mingyu Chen, Beijing (CN)

(21) Appl. No.: 14/754,019

(22) Filed: Jun. 29, 2015

Related U.S. Application Data
(63) Continuation of application No. PCT/CN2013/087316, filed on Nov. 18, 2013.

(30) Foreign Application Priority Data
Dec. 31, 2012 (CN) 201210590105.8

(51) Int. Cl. G06F 17/30

(52) U.S. Cl. CPC G06F 17/30914; G06F 17/30067

(57) ABSTRACT

A method and an apparatus for constructing a file system in a key-value storage system. According to the method for constructing a file system in a key-value storage system disclosed by the present invention, a directory number corresponding to a directory path of a directory at each level is acquired first; then, according to the directory number and a file stored in the directory at each level, corresponding keywords Key of the directory and the file are constructed.

### CROSS-REFERENCE TO RELATED APPLICATION

This application is a continuation of International Application No. PCT/CN2013/087316, filed on Nov. 18, 2013, which claims priority to Chinese Patent Application No. 201210590105.8, filed on Dec. 31, 2012, both of which are incorporated herein by reference in their entireties.

### TECHNICAL FIELD

The present invention relates to the data storage field, and in particular, to a method and an apparatus for constructing a file system in a key-value storage system, and an electronic device.

### BACKGROUND

A Key-Value (KV) storage system is a representative of a non-relational database and lifts a strict limitation on a relationship between a field structure and a table in a relational database. By enabling a key value to correspond to stored data and using a simplified data model, the KV storage system has the following advantages. First, high scalability: because there is no strict limitation on a relationship between a field structure and a table, distributed applications can be easily deployed on several servers in the KV storage system, thereby improving scalability of the entire system and achieving higher convenience and flexibility; second, adaptation to mass storage and high throughput capabilities required for cloud computing. The KV storage system can better meet a flexible requirement of a user for scalability in a cloud computing environment. Therefore, the KV storage system gradually becomes a mainstream storage platform.

A difference from a conventional manner of constructing a file system based on logical address space of a disk or disk array is that, when a file system is constructed in a KV storage system, metadata and data of the file system must be accessed in a Key-Value manner, where the Key is a preset keyword, and the Value is data that is stored in a database and that is corresponding to the keyword. Therefore, a constitution manner of the Key is critical to design of constructing the file system based on the KV storage system.

In the prior art, there are mainly two manners of constructing a Key. One is to use a hash value of file content as the Key, and the other one is to use an absolute file path as the Key. However, there are some problems in the two Key constructing manners. For example, using the hash value of the file content as the Key is applicable only to a read-only file; otherwise, when the file content is changed, its hash value is changed, which further causes the Key to change and affects file search. Therefore, the manner of using the absolute file path as the Key is commonly used. However, when the absolute file path is used as the Key, absolute file paths have a same prefix directory, and repeated prefix directories occupy large storage space. Furthermore, when an operation is performed on a directory, for example, listing files in the directory or renaming the directory, absolute file paths that use a same directory path as a prefix are first used as Keys to acquire all the files in the directory, and an operation is then performed on all the files, so as to complete the corresponding operation on the directory. The operation procedure is complex.

### SUMMARY

In view of this, the present invention is intended to provide a method for constructing a file system in a key-value storage system, and specific implementation solutions are as follows.

A first aspect of the method for constructing a file system in a key-value storage system includes: acquiring a directory at each level in the file system, and acquiring a directory number corresponding to a directory path of the directory at each level; constructing, according to the directory number and a file stored in the directory at each level, keywords of the directory and the file; and constructing and storing mapping relationships between the keywords and directory metadata, file metadata, the directory, and the file.

With reference to the first aspect, in a first possible implementation manner of the first aspect, the procedure for constructing the keywords includes, when a constructed keyword is a keyword of a directory, using a directory number corresponding to the directory as the keyword of the directory; when a constructed keyword is a keyword of a complete file, acquiring a directory number corresponding to a prefix directory of the file, and constructing information, which includes the directory number and a name of the file, as the keyword of the file; and when a constructed keyword is a keyword of a fragmented file, acquiring a directory number corresponding to a prefix directory of the fragmented file, and a number of each file fragment; and constructing information, which includes the directory number, a file name, and the number of each file fragment, as a keyword of each file fragment.

Correspondingly, the present invention further discloses an apparatus for constructing a file system in a key-value storage system. A first aspect of the apparatus for constructing a file system in a key-value storage system includes: a directory number acquiring module, configured to acquire a directory at each level in the file system, and acquire a directory number corresponding to a directory path of the directory at each level; a keyword constructing module, configured to construct, according to the directory number and a file stored in the directory at each level, keywords of the directory and the file; and a mapping relationship constructing module, configured to construct and store mapping relationships between the keywords and directory metadata, file metadata, the directory, and the file.

With reference to the first aspect, in a first possible implementation manner of the first aspect, the mapping relationship constructing module includes: a first constructing unit, configured to, when a constructed keyword is a keyword of a directory, use a directory number corresponding to the directory as the keyword of the directory; a second constructing unit, configured to, when a constructed keyword is a keyword of a complete file, acquire a directory number corresponding to a prefix directory of the file, and construct information, which includes the directory number and a name of the file, as the keyword of the file; and a third constructing unit, configured to, when a constructed keyword is a keyword of a fragmented file, acquire a directory number corresponding to a prefix directory of the fragmented file, and a number of each file fragment; and construct information, which includes the directory number, a file name, and the number of each file fragment, as a keyword of each file fragment.

Correspondingly, the present invention further discloses an electronic device, where the electronic device includes the foregoing apparatus for constructing a file system in a key-value storage system.

In addition, the present invention further discloses an electronic device, where the electronic device includes a processor and a memory connected to the processor, where the processor is configured to acquire a directory at each level in a file system; acquire a directory number corresponding to a directory path of the directory at each level; construct, according to the directory number and a file stored in the directory at each level, keywords of the directory and the file; and construct and store mapping relationships between the keywords and directory metadata, file metadata, the directory, and the file; and the memory is configured to store information that includes a program run by the processor.

According to the method for constructing a file system in a key-value storage system disclosed by the present invention, a directory number corresponding to a directory path of a directory at each level is acquired first; then, according to the directory number and a file stored in the directory at each level, corresponding keywords Key of the directory and the file are constructed. In this case, because the directory number in the keywords Key occupies relatively small space and each directory number is unique and not repeated, storage space is effectively reduced. In addition, because the directory keyword Key corresponding to the directory is constructed according to the directory number, when an operation needs to be performed on the directory, the to-be-operated directory can be directly acquired according to the directory keyword Key, which simplifies the operation procedure.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention.

FIG. 1 is a schematic diagram of a Key-Value storage form in a key-value storage system;

FIG. 2 is a schematic diagram of a working procedure of a method for constructing a file system in a key-value storage system according to an embodiment of the present invention;

FIG. 3 is a schematic diagram of a working procedure for acquiring a to-be-read file in the method for constructing a file system in a key-value storage system according to the embodiment of the present invention;

FIG. 4 is a schematic diagram of a working procedure for acquiring a to-be-written file in the method for constructing a file system in a key-value storage system according to the embodiment of the present invention;

FIG. 5 is a schematic diagram of a working procedure for listing a file in a same directory in the method for constructing a file system in a key-value storage system according to the embodiment of the present invention;

FIG. 6 is a schematic diagram of a working procedure for performing a rename operation on a directory in the method for constructing a file system in a key-value storage system according to the embodiment of the present invention;

FIG. 7 is a schematic diagram of a working procedure for changing directory path access permission in the method for constructing a file system in a key-value storage system according to the embodiment of the present invention;

FIG. 8 is a schematic diagram of a working procedure for changing file path access permission in the method for constructing a file system in a key-value storage system according to the embodiment of the present invention;

FIG. 9 is a schematic structural diagram of an apparatus for constructing a file system in a key-value storage system according to an embodiment of the present invention;

FIG. 10 is a schematic structural diagram of a mapping relationship constructing module in the apparatus for constructing a file system in a key-value storage system according to the embodiment of the present invention;

FIG. 11 is a schematic structural diagram of a reading module in the apparatus for constructing a file system in a key-value storage system according to the embodiment of the present invention;

FIG. 12 is a schematic structural diagram of a writing module in the apparatus for constructing a file system in a key-value storage system according to the embodiment of the present invention;

FIG. 13 is a schematic structural diagram of a listing module in the apparatus for constructing a file system in a key-value storage system according to the embodiment of the present invention;

FIG. 14 is a schematic structural diagram of a renaming module in the apparatus for constructing a file system in a key-value storage system according to the embodiment of the present invention;

FIG. 15 is a schematic structural diagram of a directory path permission changing module in the apparatus for constructing a file system in a key-value storage system according to the embodiment of the present invention; and

FIG. 16 is a schematic structural diagram of a file path permission changing module in the apparatus for constructing a file system in a key-value storage system according to the embodiment of the present invention.

### DESCRIPTION OF EMBODIMENTS

The following clearly describes the technical solutions in the embodiments of the present invention with reference to the accompanying drawings in the embodiments of the present invention. The described embodiments are merely some but not all of the embodiments of the present invention.

Refer to FIG. 1, which shows a schematic structural diagram of a Key-Value storage form in key-value storage system. In the KV storage system, a keyword, namely a Key, is created in advance, data stored in the storage system, namely a Value, is created, and a mapping relationship between the Key and the Value, which is called a Key-Value form <Key, value>, is also created. Therefore, the data Value stored in the KV storage system can be acquired according to the keyword Key.

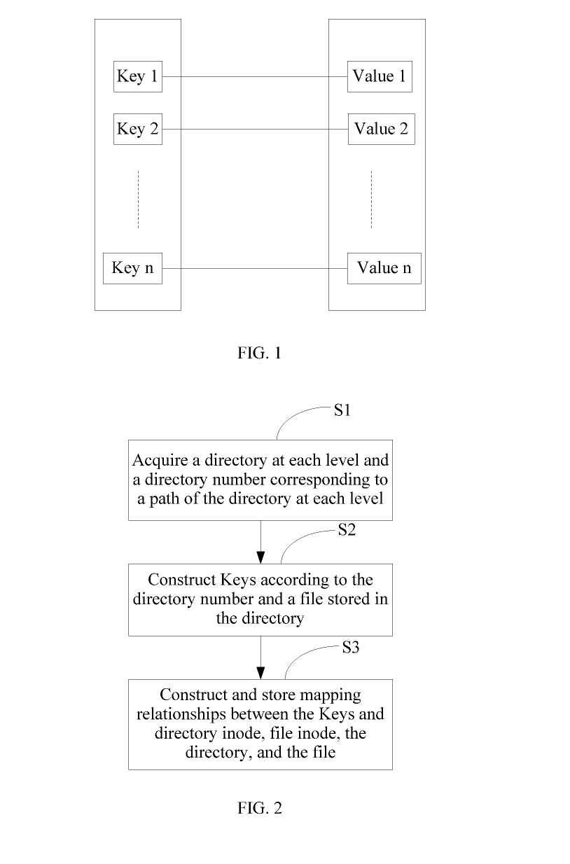

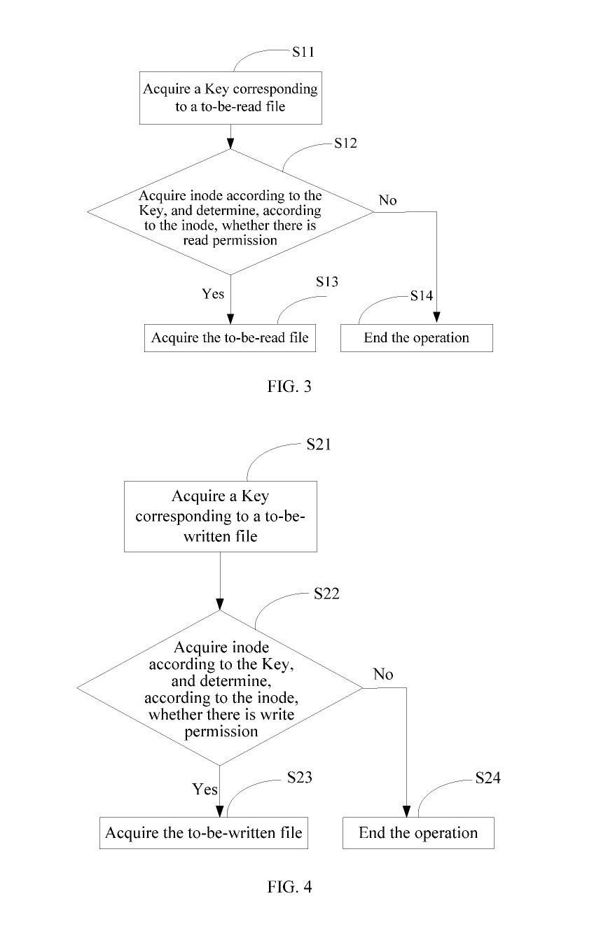

In order to resolve problems in the prior art that in a KV storage system, occupied storage space is large when a file system is constructed according to a keyword Key, and a process is complex when data stored in the storage system is acquired according to the keyword, the present invention provides a method for constructing a file system in a key-value storage system. Refer to FIG. 2, which shows a schematic diagram of a working procedure. The method for constructing a file system in a key-value storage system includes the flowing steps.

Step S1. Acquire a directory at each level in the file system, and acquire a directory number/identifier (dirid) corresponding to a directory path of the directory at each level.

The dirid corresponding to each directory is unique, and may be a numeric number, such as 1, 2, or 3. For example, in the file system, if a directory path of a directory is “/home/patent/2011dir/”, a dirid being 1 may be created for the directory path. Correspondingly, a directory path of an upper-level directory is “/home/patent/” and also called a prefix directory of the directory, and another dirid being 2 may be created. Certainly, the dirid may also be created in another form, which is not limited in the present invention.

Step S2. According to the directory number, and a file stored in the directory at each level, construct keywords of the directory and the file.

Step S3. Construct and store mapping relationships between the keywords and the directory, the file, directory metadata inode, and file metadata inode.

Indexes, an owner, access permission, and the like of the directory and the file in the storage system are pre-stored in the directory metadata inode and the file metadata inode.

After the keywords of the directory and the file are constructed according to the directory number and the file stored in the directory, and the mapping relationships between the keywords and the directory metadata inode and the file metadata inode are constructed and stored, the metadata can be acquired according to the keywords, so as to learn whether there is permission to perform an operation on the directory and the file. When there is the permission to perform an operation on the directory and the file, the corresponding directory and file can be acquired according to the keywords, so as to perform the operation on the directory and the file.

Correspondences between the keywords and the directory and the file are stored, so that the directory and the file corresponding to the keywords can be acquired according to the keywords.

According to the method for constructing a file system in a key-value storage system disclosed by the present invention, a directory number corresponding to a directory path of a directory at each level is acquired first; then, according to the directory number and a file stored in the directory at each level, corresponding keywords of the directory and the file are constructed. In this case, because the directory number in the keywords occupies relatively small space and each directory number is unique and not repeated, storage space is effectively reduced. In addition, because the directory keyword corresponding to the directory is constructed according to the directory number, when an operation needs to be performed on the directory, the to-be-operated directory can be directly acquired according to the directory keyword, which simplifies the operation procedure.

Further, in step S2, the procedure for constructing the keywords includes, when a constructed keyword is a keyword of a directory, using a directory number corresponding to the directory as the keyword of the directory; when a constructed keyword is a keyword of a complete file, acquiring a directory number corresponding to a prefix directory of the file, and constructing information, which includes the directory number and a name of the file, as the keyword of the file; and when a constructed keyword is a keyword of a fragmented file, acquiring a directory number corresponding to a prefix directory of the fragmented file, and a number of each file fragment; and constructing information, which includes the directory number, a file name, and the number of each file fragment, as a keyword of each file fragment.

When the constructed keyword is the keyword of the directory, a directory number corresponding to a directory path of the directory can be used as the keyword of the directory; in this case, a Key-Value form of the directory is <dirid, value>, and a quantity of entries is a total quantity of directories at all levels. For example, when a directory number of a directory path “/home/patent/2011dir/” is set to 1, a keyword of a directory is 1, and the directory may be acquired according to a mapping relationship between the keyword and the directory.

When the constructed keyword is the keyword of the complete file, the keyword of the file includes the directory number and the name of the file. For example, if a file named “pat1” is stored in a file system and a file path of the file is “/home/patent/2011dir/pat1”, “/home/patent/2011dir” is a prefix directory of the file. When a dirid of this prefix directory is 1, a keyword of the file “pat1” may be “1/pat1”, and certainly may also be represented in another form. In this case, a file Key-Value form is <dirid/filename, value>, and a quantity of entries is a total quantity of files.

In the KV storage system, when stored data is a file, the file may be stored as a complete file, that is, in a form of one Value; or the file may be fragmented and stored as multiple file fragments, that is, in a form of multiple Values. When the file is divided into multiple file fragments and a keyword of each file fragment is constructed the keyword is set to include a directory number, a file name, and a file fragment number. For example, the file “pat1” is divided into multiple file fragments, and numbers of the file fragments are 1, 2, 3, and so on; then, a keyword of the first file fragment includes the directory number of the prefix directory, the file name, and a file fragment number 1, may be represented in a form of “1/pat1/1”, and certainly may be represented in another form.

When keyword construction is implemented according to the method described in step S1 to step S3, in practical application, another operation, for example, reading file content and writing data into a file, further needs to be performed on the file system.

In addition, the file system provides a portable operating system interface (POSIX) externally, while the KV storage system provides a simple input/output (I/O) interface externally, such as PUT, GET, and DELETE interface. By invoking the interfaces provided by the KV storage system, the file system constructed based on the key-value storage system may be connected to the outside, such as an upper-layer application system.

Refer to FIG. 3, which shows a schematic diagram of a working procedure. After the keywords are constructed, when file content needs to be read, that is, a Read operation needs to be performed on the KV storage system, the following steps are included:

Step S11. When the file content needs to be read, acquire a keyword corresponding to a to-be-read file. When the keyword is acquired, the keyword of the file can be acquired according to a prefix directory and a file name of the to-be-read file; if the file is a fragmented file, the keyword can be acquired according to the prefix directory and the file name of the file, and a number of each file fragment.

Step S12. Acquire metadata inode of the to-be-read file according to the keyword; determine, according to the metadata, whether there is read permission; and when there is the read permission, perform an operation in step S13; or when there is no read permission, perform an operation in step S14.

Step S13. When there is the read permission, acquire the to-be-read file according to the keyword, so as to perform the read operation.

Step S14. End the operation.

In the foregoing method, when the read operation is performed, an upper-layer application program may acquire the to-be-read file from the KV storage system by using a GET interface.

After the upper-layer application program acquires the to-be-read file, the upper-layer application program may capture, according to a start address of to-be-read content and a size of the to-be-read content, content of [offset, offset+size) in a KV database, and display the content, where offset represents a start address of an I/O operation, and size indicates a size of an I/O. In this method, offset represents the start address of the content to be read this time, and size represents a size of data that is output this time. Capturing the content of [offset, offset+size) and returning it to the upper-layer application for display may enable the staff to acquire the to-be-read content in the file. If the file is a fragmented file, after content of multiple file fragments corresponding to [offset, offset+size) is captured, the file content needs to be spliced according to numbers of the file fragments, and displayed by the upper-layer application.

Refer to FIG. 4, which shows a schematic diagram of a working procedure. After the keywords are constructed, when data needs to be written into a file, that is, a Write operation needs to be performed, the following steps are included.

Step S21. When the data needs to be written into the file, acquire a keyword corresponding to the to-be-written file. When the keyword is acquired, the keyword of the file can be acquired according to a prefix directory and a file name of the to-be-written file; if the file is a fragmented file, the keyword can be acquired according to the prefix directory and the file name of the file, and a number of each file fragment.

Step S22. Acquire metadata inode of the to-be-written file according to the keyword; determine, according to the metadata inode, whether there is write permission; and when there is the write permission, perform an operation in step S23; or when there is no write permission, perform an operation in step S24.

Step S23. Acquire the to-be-written file according to the keyword, so as to perform the write operation.

Step S24. End the operation.

Similar to the operation of reading the file content, when the write operation is performed, the upper-layer application program acquires the to-be-written file from the KV storage system by using the GET interface, updates data of [offset, offset+size) in file data, and puts the updated data into the KV storage system by using a PUT interface. In this case, offset indicates a start address of to-be-written data in the file, and size indicates a size of the data that is input this time. After the write operation is complete, the written file is stored into the KV storage system by using the PUT interface.

In addition, when the data of [offset, offset+size) in the file data is updated and the updated data is stored into the KV storage system, if the to-be-written file includes multiple file fragments, the file fragments are updated separately, updated file content is spliced according to numbers of the file fragments, and then the spliced file content is written into the KV storage system.

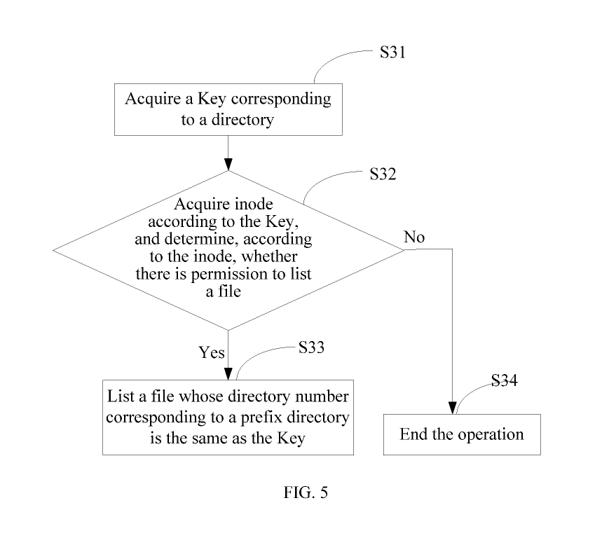

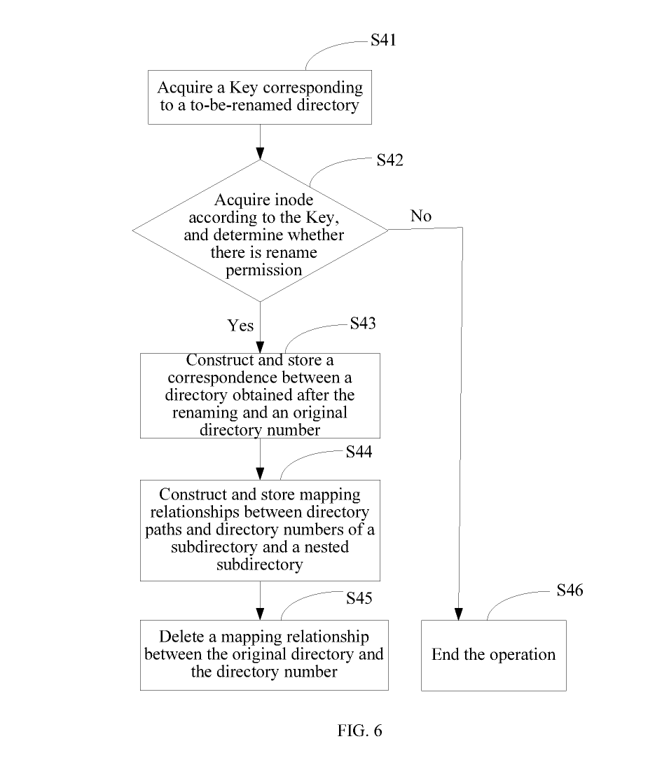

Refer to FIG. 5, which shows a schematic diagram of a working procedure. After the keywords are constructed, when a file in a same directory needs to be listed, that is, a Readdir operation needs to be performed on the KV storage system, the following steps are included.

Step S31. When the file in the same directory needs to be listed, acquire a keyword corresponding to the directory. When the keyword is acquired, a directory number corresponding to a directory path, namely the keyword corresponding to the directory is acquired according to the directory path of the directory.

Step S32. Acquire metadata inode of the directory according to the keyword; determine, according to the metadata, whether there is permission to list the file in the directory; and when there is the permission to list the file in the directory, perform an operation in step S33; or when there is no permission to list the file in the directory, perform an operation in step S34.

Step S33. When there is the permission to list the file in the directory, list, according to the keyword, a file whose directory number corresponding to a prefix directory path is the same as the keyword of the directory.

Step S34. End the operation.

For example, when a file path of a file named “pat1” is “/home/patent/2011dir/pat1”, a prefix directory of the file is “/home/patent/2011dir/”. When a directory number corresponding to the path of the prefix directory is the same as a keyword of a to-be-operated directory, it indicates that the file is a file stored in the directory. When a file whose directory number corresponding to a prefix directory path is the same as the keyword of the directory is listed, it is implemented that all files in the directory are listed.

Refer to FIG. 6, which shows a schematic diagram of a working procedure. After the keywords are constructed, when a directory needs to be renamed, that is, a rename operation needs to be performed, the following steps are included:

Step S41. When the directory needs to be renamed, acquire a keyword corresponding to the to-be-renamed directory.

Step S42. Acquire metadata inode of the to-be-renamed directory according to the keyword; determine, according to the metadata inode, whether there is permission to rename the directory; and when there is the permission to rename the directory, perform an operation in step S43; or when there is no permission to rename the directory, perform an operation in step S46.

Step S43. When there is the permission to rename the directory, after the rename operation is performed on the to-be-renamed directory, construct and store a mapping relationship between a directory number corresponding to the original directory and a directory obtained after the renaming, where the original directory is a directory before the rename operation is performed.

After the mapping relationship between the directory number corresponding to the original directory and the directory obtained after the renaming is constructed, the directory obtained after the renaming may be acquired according to the original directory number, and there is no need to construct a new directory number.

Step S44. Construct and store mapping relationships between directory paths, which are of a subdirectory and its nested subdirectory in the directory obtained after the renaming, and directory numbers of the subdirectory and the nested subdirectory.

After the rename operation is performed on the directory, directory paths of all subdirectories and all nested subdirectories in the directories change correspondingly. Therefore, new mapping relationships between the directory paths, which are of the subdirectory and the nested subdirectory, and the directory numbers of the subdirectory and the nested subdirectory need to be constructed, so that the corresponding directory can be acquired correctly according to the directory number that is used as the keyword.

Step S45. Delete a mapping relationship between the original directory and the directory number from the key-value storage system.

Step S46. End the operation.

In step S45, when the mapping relationship between the original directory and the directory number is deleted, a DELETE interface may be invoked for implementation.

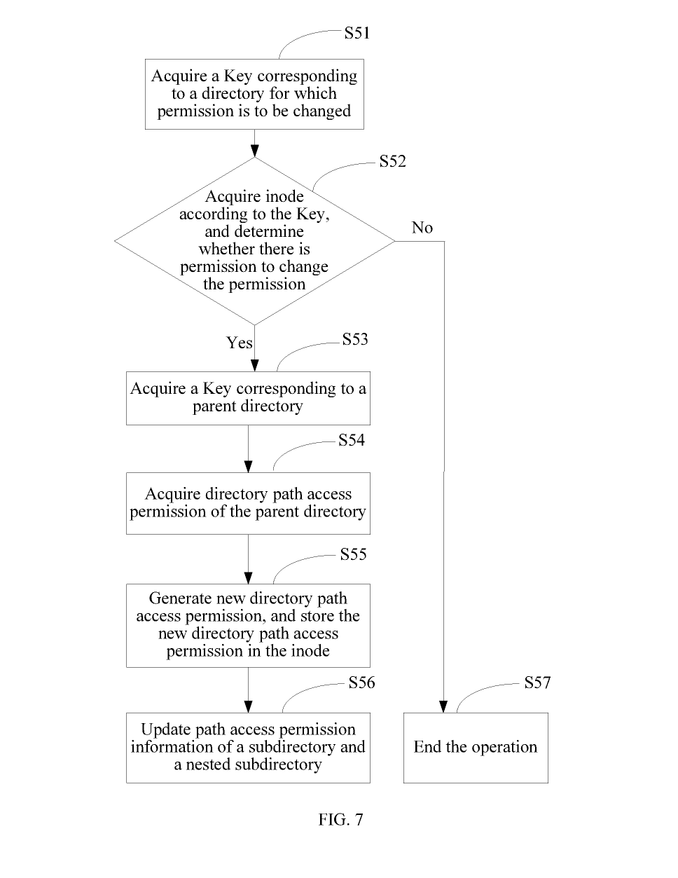

Refer to FIG. 7, which shows a schematic diagram of a working procedure. After the keywords are constructed, when permission for a directory path needs to be changed, that is, a chmod operation needs to be performed, the following steps are included:

Step S51. When the permission for the directory needs to be changed, acquire a keyword corresponding to the directory.

Step S52. Acquire, according to the keyword, directory metadata inode corresponding to the directory; determine, according to the metadata, whether there is permission to change the permission for the directory; and when there is the permission to change the permission for the directory, perform an operation in step S53; or when there is no permission to change the permission for the directory, perform an operation in step S57.

Step S53. Acquire a keyword corresponding to a parent directory of the directory. When the keyword corresponding to the parent directory is acquired, a directory path of the parent directory may be obtained according to a prefix directory of the directory, a directory number corresponding to the directory path of the parent directory is acquired, and then the keyword corresponding to the parent directory can be acquired.

Step S54. Acquire, according to the keyword corresponding to the parent directory, metadata inode corresponding to the parent directory, and acquire path access permission information of the parent directory according to the metadata inode.

Step S55. Generate updated path access permission for the directory according to the path access permission information of the parent directory and updated directory access permission information, and update, according to the updated path access permission for the directory, directory path permission information in directory metadata inode corresponding to the directory.

Each directory or file has two types of permission, namely, path access permission and directory or file access permission. The path access permission and the directory or file access permission are stored in their corresponding directory metadata inode or file metadata inode. The directory or file access permission is set by the upper-layer application program. When the path access permission and the directory or file access permission are updated, the upper-layer application program puts the updated directory or file access permission into the KV storage system by using the PUT interface; after the updated directory or file access permission is acquired, updated path access permission is generated by using a path access permission generation rule. A path access permission generation rule for a directory is: path access permission for the directory=path access permission for a parent directory & directory access permission.

Step S56. According to the updated directory path permission information, update path access permission information of a subdirectory and its nested subdirectory in the directory.

Step S57. End the operation.

In step S56, when the path access permission information of the subdirectory in the directory is updated, the directory for which path permission has been updated is used as a parent directory of the subdirectory, and path access permission for the subdirectory is generated according to directory access permission information of the subdirectory and a path access permission generation rule for the directory, where the directory access permission information of the subdirectory is transmitted to the KV storage system by the upper-layer application program.

When path access permission for the nested subdirectory is updated, the subdirectory is used as a parent directory of the nested subdirectory, and the path access permission for the nested subdirectory is updated in the foregoing manner.

According to the method for updating path access permission disclosed by the foregoing solution, when path access permission for a directory is changed, path access permission for a subdirectory and a nested subdirectory at each level in the directory are updated, and updated path access permission information is stored in their corresponding metadata inode.

Refer to FIG. 8, which shows a schematic diagram of a working procedure. After the keywords are constructed, when path access permission for a file needs to be changed, that is, a chmod operation needs to be performed, the following steps are included.

Step S61. When permission for the file needs to be changed, acquire a keyword corresponding to the file.

Step S62. Acquire file metadata corresponding to the file according to the keyword; determine, according to the metadata, whether there is permission to change the permission for the file; and when there is the permission to change the permission for the file, perform an operation in step S63; or when there is no permission to change the permission for the file, perform an operation in step S65.

Step S63. Acquire path access permission information of a prefix directory of the file.

Specifically, when path access permission for the prefix directory is acquired, a keyword corresponding to the prefix directory is first acquired, prefix directory metadata inode corresponding to the prefix directory is then acquired according to the keyword, and further, the path access permission information of the prefix directory is acquired.

Step S64. Generate updated path access permission for the file according to the path access permission information of the prefix directory and updated file access permission information, and update file path permission information in the file metadata corresponding to the file.

A path access permission generation rule for a file is path access permission for the file=path access permission for a prefix directory & file access permission.

Step S65. End the operation.

According to the method for constructing a file system in a key-value storage system disclosed by the present invention, a directory number corresponding to a directory path of a directory at each level is acquired first; then, according to the directory number and a file stored in the directory at each level, corresponding keywords of the directory and the file are constructed. In this case, because the directory number in the keywords occupies relatively small space and each directory number is unique and not repeated, storage space is effectively reduced. In addition, because the directory keyword corresponding to the directory is constructed according to the directory number, when an operation needs to be performed on the directory, the to-be-operated directory can be directly acquired according to the directory keyword, which simplifies the operation procedure.

Specifically, in the prior art, if an absolute file path is used as a Key, each file is corresponding to one record in a key-value storage system. A quantity N of records corresponding to a directory is equal to the sum of a quantity N1 of all files included in the directory and a quantity N2 of all files included in a nested subdirectory of the directory, that is, N=N1+N2. When a rename operation needs to be performed on a directory, all N records corresponding to the directory need to be extracted from the key-value storage system, and the N records are written into the key-value storage system after a Key is updated, that is, the operation needs to be performed for N times.

However, according to the method disclosed in the present application, each directory is corresponding to one directory number, and a quantity of records corresponding to a directory is equal to a total quantity M of subdirectories included in the directory. The quantity M is far less than the quantity N of records corresponding to a directory in the foregoing technical solution in which an absolute file path is used as a keyword. When a rename operation is performed on a directory, all M records corresponding to the directory need to be extracted from a key-value storage system, and the M records are written into the key-value storage system after a Key is updated, that is, the operation needs to be performed for M times.

By comparison, the quantity N of times of the operation on the directory in the prior art is much greater than the quantity M of times in the method disclosed in the solution. In addition, when each operation is performed, a Key-Value pair in the prior art is <absolute file path, file content>, while in the method disclosed in the solution, a Key-Value pair is <directory number, directory content>, or <directory number/file name, file content>, or <directory number/file name/file fragment number, file fragment content>. Compared with the absolute file path, the directory number, the directory number/file name, and the directory number/file name/file fragment number occupy less storage space.

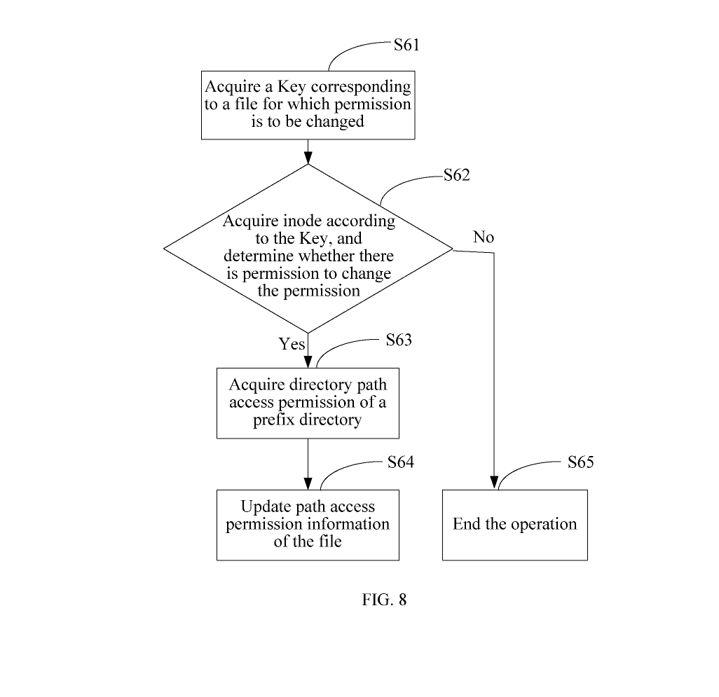

Correspondingly, the present invention further discloses an apparatus for constructing a file system in a key-value storage system. Refer to FIG. 9, which shows a schematic structural diagram. The apparatus includes a directory number acquiring module 1, a keyword constructing module 2, and a mapping relationship constructing module 3, where the directory number acquiring module 1 is configured to acquire a directory at each level in the file system, and acquire a directory number corresponding to a directory path of the directory at each level; the keyword constructing module 2 is configured to construct, according to the directory number and a file stored in the directory at each level, keywords of the directory and the file; and the mapping relationship constructing module 3 is configured to construct and store mapping relationships between the keywords and directory metadata, file metadata, the directory, and the file.

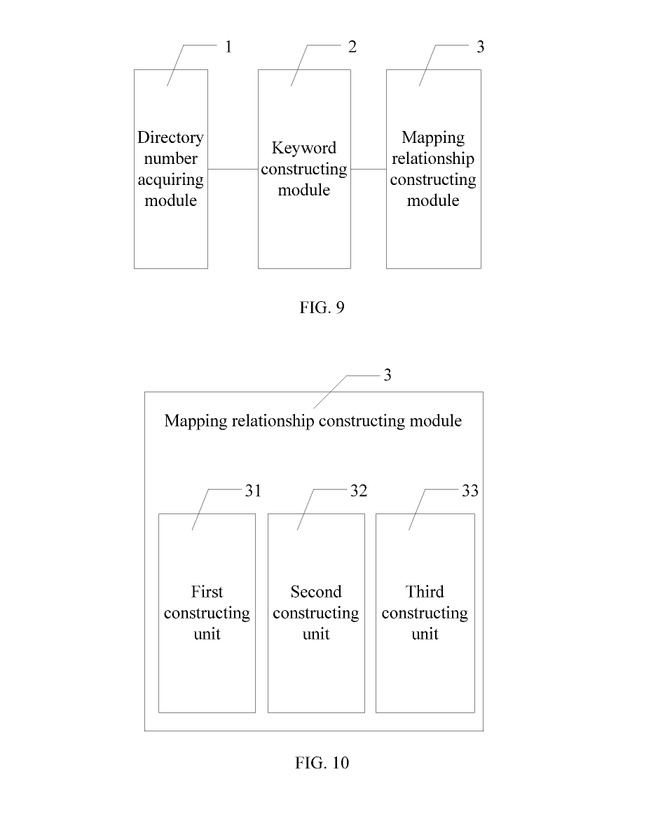

Refer to FIG. 10, which shows a schematic structural diagram. The mapping relationship constructing module 3 includes a first constructing unit 31, a second constructing unit 32, and a third constructing unit 33, where the first constructing unit 31 is configured to, when a constructed keyword is a keyword of a directory, use a directory number corresponding to the directory as the keyword of the directory; the second constructing unit 32 is configured to, when a constructed keyword is a keyword of a complete file, acquire a directory number corresponding to a prefix directory of the file, and construct information, which includes the directory number and a name of the file, as the keyword of the file; and the third constructing unit 33 is configured to, when a constructed keyword is a keyword of a fragmented file, acquire a directory number corresponding to a prefix directory of the fragmented file, and a number of each file fragment; and construct information, which includes the directory number, a file name, and the number of each file fragment, as a keyword of each file fragment.

Further, refer to FIG. 11, which shows a schematic structural diagram. The apparatus for constructing a file system in a key-value storage system further includes a reading module 4, where the reading module 4 includes a first keyword acquiring unit 41, a first determining unit 42, and a to-be-read file acquiring unit 43, where the first keyword acquiring unit 41 is configured to, when file content needs to be read, acquire a keyword corresponding to a to-be-read file; the first determining unit 42 is configured to acquire metadata of the to-be-read file according to the keyword, and determine, according to the metadata, whether there is read permission; and the to-be-read file acquiring unit 43 is configured to, when there is the read permission, acquire the to-be-read file according to the keyword, so as to perform a read operation.

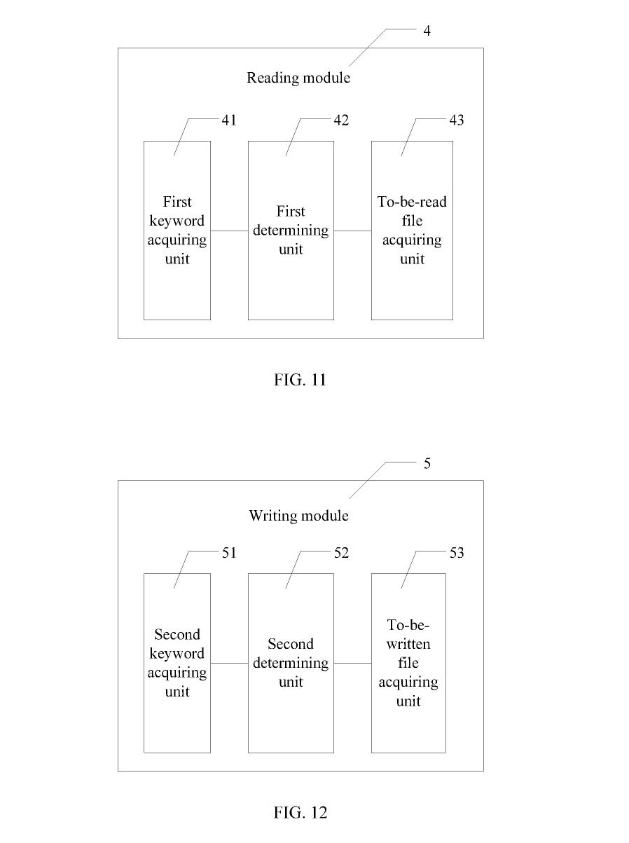

Further, refer to FIG. 12, which shows a schematic structural diagram. The apparatus for constructing a file system in a key-value storage system further includes a writing module 5, where the writing module 5 includes a second keyword acquiring unit 51, a second determining unit 52, and a to-be-written file acquiring unit 53, where the second keyword acquiring unit 51 is configured to, when data needs to be written into a file, acquire a keyword corresponding to the to-be-written file; the second determining unit 52 is configured to acquire metadata of the to-be-written file according to the keyword, and determine, according to the metadata, whether there is write permission; and the to-be-written file acquiring unit 53 is configured to, when there is the write permission, acquire the to-be-written file according to the keyword, so as to perform a write operation.

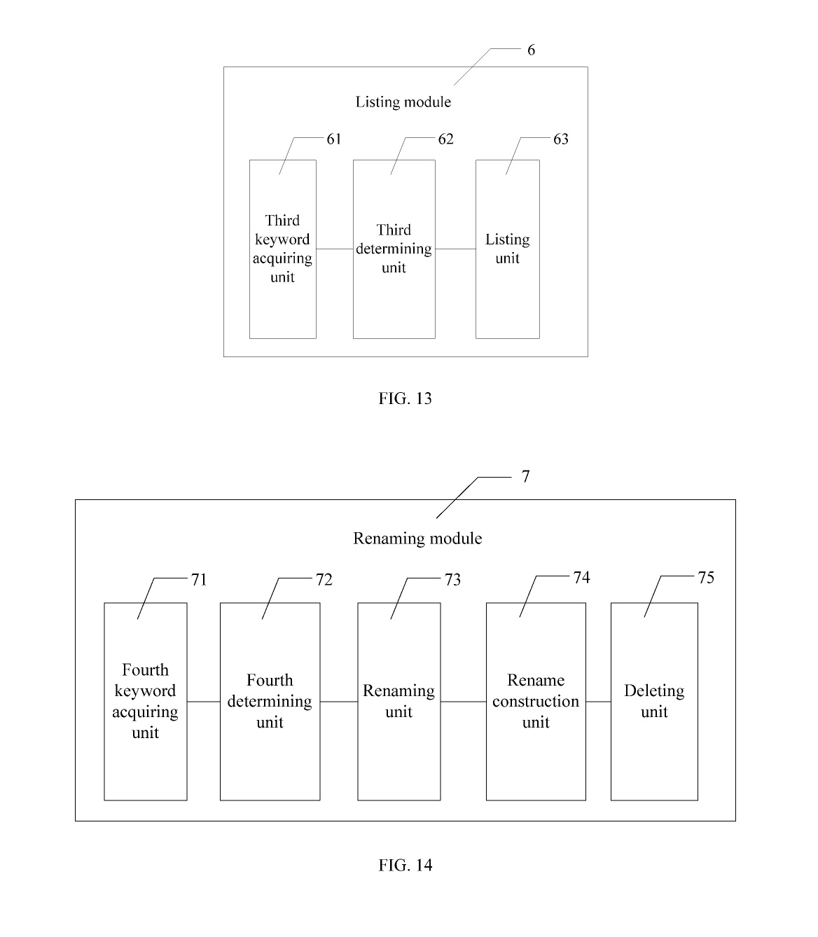

Further, refer to FIG. 13, which shows a schematic structural diagram. The apparatus for constructing a file system in a key-value storage system further includes a listing module 6, where the listing module 6 includes a third keyword acquiring unit 61, a third determining unit 62, and a listing unit 63, where the third keyword acquiring unit 61 is configured to, when a file in a same directory needs to be listed, acquire a keyword corresponding to the directory; the third determining unit 62 is configured to acquire metadata of the directory according to the keyword, and determine, according to the metadata, whether there is permission to list the file in the directory; and the listing unit 63 is configured to, when there is the permission to list the file in the directory, list, according to the keyword, a file whose directory number corresponding to a prefix directory path is the same as the keyword of the directory.

Further, refer to FIG. 14, which shows a schematic structural diagram. The apparatus for constructing a file system in a key-value storage system further includes a renaming module 7, where the renaming module 7 includes a fourth keyword acquiring unit 71, a fourth determining unit 72, a renaming unit 73, a rename constructing unit 74, and a deleting unit 75, where the fourth keyword acquiring unit 71 is configured to, when a directory needs to be renamed, acquire a keyword corresponding to the to-be-renamed directory; the fourth determining unit 72 is configured to acquire metadata of the to-be-renamed directory according to the keyword, and determine, according to the metadata, whether there is permission to rename the directory; the renaming unit 73 is configured to, when there is the permission to rename the directory, after a rename operation is performed on the to-be-renamed directory, construct and store a mapping relationship between a directory number corresponding to the original directory and a directory obtained after the renaming, where the original directory is a directory before the rename operation is performed; the rename constructing unit 74 is configured to construct and store mapping relationships between directory paths, corresponding to a subdirectory and a nested subdirectory in the directory obtained after the renaming, and directory numbers of the subdirectory and the nested subdirectory; and the deleting unit 75 is configured to delete a mapping relationship between the original directory and the directory number from the file storage system.

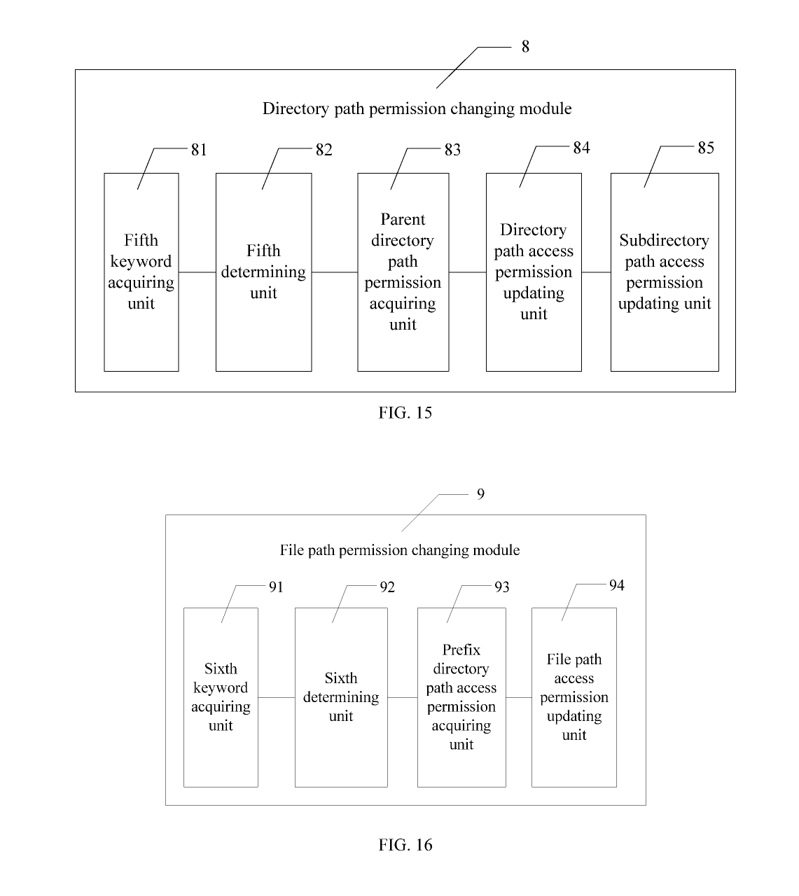

Further, refer to FIG. 15, which shows a schematic structural diagram. The apparatus for constructing a file system in a key-value storage system further includes a directory path permission changing module 8, where the directory path permission changing module 8 includes a fifth keyword acquiring unit 81, a fifth determining unit 82, a parent directory path permission acquiring unit 83, a directory path access permission updating unit 84, and a subdirectory path access permission updating unit 85, where the fifth keyword acquiring unit 81 is configured to, when path access permission for a directory needs to be changed, acquire a keyword corresponding to the directory; the fifth determining unit 82 is configured to acquire metadata of the corresponding directory according to the keyword, and determine, according to the metadata, whether there is permission to change permission for the directory; the parent directory path permission acquiring unit 83 is configured to, when there is the permission to change the permission for the directory, acquire a keyword corresponding to a parent directory of the directory, and acquire path access permission information of the parent directory according to the keyword; the directory path access permission updating unit 84 is configured to generate updated path access permission for the directory according to the path access permission information of the parent directory and updated directory access permission information, and update directory path permission information in directory metadata corresponding to the directory; and the subdirectory path access permission updating unit 85 is configured to update, according to the updated directory path permission information, path access permission information in directory metadata corresponding to a subdirectory and its nested subdirectory in the directory.

Further, refer to FIG. 16, which shows a schematic structural diagram. The apparatus for constructing a file system in a key-value storage system further includes a file path permission changing module 9, where the file path permission changing module 9 includes a sixth keyword acquiring unit 91, a sixth determining unit 92, a prefix directory path access permission acquiring unit 93, and a file path access permission updating unit 94, where the sixth keyword acquiring unit 91 is configured to, when permission for a file needs to be changed, acquire a keyword corresponding to the file; the sixth determining unit 92 is configured to acquire, according to the keyword, file metadata corresponding to the file, and determine, according to the metadata, whether there is permission to change the permission for the file; the prefix directory path access permission acquiring unit 93 is configured to, when there is the permission to change the permission for the file, acquire a keyword corresponding to a prefix directory of the file, and acquire path access permission information of the prefix directory according to the keyword; and the file path access permission updating unit 94 is configured to generate updated path access permission for the file according to the path access permission information of the prefix directory and updated file access permission information, and update file path access permission information in the file metadata corresponding to the file.

In the apparatus for constructing a file system in a key-value storage system disclosed by the present invention, firstly, a directory number acquiring module acquires a directory number corresponding to a directory path of a directory at each level; then, a keyword constructing module constructs, according to the directory number and a file stored in the directory at each level, corresponding keywords of the directory and the file; and then, a mapping relationship constructing module constructs and stores mapping relationships between the keywords and directory metadata, file metadata, the directory, and the file. In this case, because the directory number in the keywords occupies relatively small space and each directory number is unique and not repeated, storage space is effectively reduced. In addition, because the directory keyword corresponding to the directory is constructed according to the directory number, when an operation needs to be performed on the directory, the to-be-operated directory can be directly acquired according to the directory keyword, which simplifies the operation procedure.

Correspondingly, the present invention further discloses an electronic device, where the electronic device includes the foregoing apparatus for constructing a file system in a key-value storage system; and the apparatus for constructing a file system in a key-value storage system includes a directory number acquiring module, a keyword constructing module, and a mapping relationship constructing module, and may further includes a reading module, a writing module, a listing module, a renaming module, a directory path permission changing module, and a file permission changing module.

Correspondingly, the present invention further discloses an electronic device, where the electronic device includes a processor and a memory connected to the processor, where the processor is configured to acquire a directory at each level in a file system; acquire a directory number corresponding to a directory path of the directory at each level; construct, according to the directory number and a file stored in the directory at each level, keywords of the directory and the file; and construct and store mapping relationships between the keywords and directory metadata, file metadata, the directory, and the file; and the memory is configured to store information that includes a program run by the processor.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present invention. The foregoing storage medium includes: any medium that can store program code, such as a Universal Serial Bus (USB) flash drive, a removable hard disk, a read-only memory (ROM), a random access memory (RAM), a magnetic disk, or an optical disc.

The foregoing descriptions of the disclosed embodiments enable a person skilled in the art to implement and use the present invention. Therefore, the present invention will not be limited to the embodiments described in this specification but extends to the widest scope that complies with the principles and novelty disclosed in this specification.

What is claimed is:

1. A method for constructing a file system in a key-value storage system implemented by a server, comprising:
acquiring a directory at each level in the file system;
acquiring a directory number corresponding to a directory path of the directory at each level;
constructing, according to the directory number and a file stored in the directory at each level, keywords of the directory and the file; and
constructing and storing mapping relationships between the keywords and directory metadata, file metadata, the directory, and the file.

2. The method according to claim 1, wherein constructing the keywords comprises:
using a directory number corresponding to the directory as the keyword of the directory when a constructed keyword is a keyword of the directory;
acquiring a directory number corresponding to a prefix directory of the complete file when a constructed keyword is a keyword of a complete file;
constructing information, which comprises the directory number and a name of the complete file, as the keyword of the complete file;
acquiring a directory number corresponding to a prefix directory of the fragmented file and a number of each file fragment when a constructed keyword is a keyword of a fragmented file, and
constructing information, which comprises the directory number, a file name, and the number of each file fragment, as a keyword of each file fragment.

3. The method according to claim 1, wherein after constructing the keywords, the method further comprises:
acquiring a keyword corresponding to a to-be-read file when file content needs to be read;
acquiring metadata of the to-be-read file according to the keyword determining, according to the metadata, whether there is read permission; and
acquiring the to-be-read file according to the keyword, so as to perform a read operation when there is the read permission.

4. The method according to claim 1, wherein after constructing the keywords, the method further comprises:
acquiring a keyword corresponding to the to-be-written file when data needs to be written into a file;
acquiring metadata of the to-be-written file according to the keyword, and determining, according to the metadata, whether there is write permission; and
acquiring the to-be-written file according to the keyword so as to perform a write operation when there is the write permission.

5. The method according to claim 1, wherein after constructing the keywords, the method further comprises:
acquiring a keyword corresponding to the directory when a file in the same directory needs to be listed;
acquiring metadata of the directory according to the keyword;
determining, according to the metadata, whether there is permission to list the file in the directory; and
listing the file according to the keyword when there is the permission to list the file in the directory, wherein the file has a directory number corresponding to a prefix directory path is the same as the keyword of the directory.

6. The method according to claim 1, wherein after constructing the keywords, the method further comprises:
acquiring a keyword corresponding to the to-be-renamed directory when a directory needs to be renamed;
acquiring metadata of the to-be-renamed directory according to the keyword;
determining, according to the metadata, whether there is permission to rename the to-be-renamed directory;
constructing and storing a mapping relationship between a directory number corresponding to an original directory and a directory obtained after the renaming when there is the permission to rename the to-be-renamed directory and after a rename operation is performed on the to-be-renamed directory, wherein the original directory is a directory before the rename operation is performed;
constructing and storing mapping relationships between directory paths, corresponding to a subdirectory and a nested subdirectory in the directory obtained after the renaming, and directory numbers of the subdirectory and the nested subdirectory; and
deleting a mapping relationship between the original directory and a directory number from the file system.

7. The method according to claim 1, wherein after constructing the keywords, the method further comprises:
acquiring a keyword corresponding to the directory when path access permission for a directory needs to be changed;
acquiring metadata of the directory according to the keyword;
determining, according to the metadata, whether there is permission to change permission for the directory;
acquiring a keyword corresponding to a parent directory of the directory, and acquiring path access permission information of the parent directory according to the keyword when there is the permission to change the permission for the directory;
generating updated path access permission for the directory according to the path access permission information of the parent directory and updated directory access permission information;
updating directory path permission information in directory metadata corresponding to the directory; and
updating, according to the updated directory path permission information, path access permission information in directory metadata corresponding to a subdirectory and a nested subdirectory in the directory.

8. The method according to claim 1, wherein after constructing the keywords, the method further comprises:
acquiring a keyword corresponding to the file when permission for a file needs to be changed;
acquiring, according to the keyword, file metadata corresponding to the file;
determining, according to the metadata, whether there is permission to change the permission for the file;
acquiring a keyword corresponding to a prefix directory of the file when there is the permission to change the permission for the file;
acquiring path access permission information of the prefix directory according to the keyword;
generating updated path access permission for the file according to the path access permission information of the prefix directory and updated file access permission information; and
updating file path access permission information in the file metadata corresponding to the file.

9. An apparatus for constructing a file system in a key-value storage system, comprising:
a processor; and
a memory, wherein the processor is configured to execute computer-executable instructions stored in the memory that cause the processor to perform operations of:
acquiring a directory at each level in the file system;
acquiring a directory number corresponding to a directory path of the directory at each level;
constructing, according to the directory number and a file stored in the directory at each level, keywords of the directory and the file; and
constructing and storing mapping relationships between the keywords and directory metadata, file metadata, the directory, and the file.

10. The apparatus according to claim 9, wherein the keyword of the directory is a directory number corresponding to the directory when a constructed keyword is a keyword of a directory, wherein the keyword of the file comprises a directory number corresponding to a prefix directory of the file and a name of the file when a constructed keyword is a keyword of the file, and wherein the keyword of the file fragment comprises a directory number corresponding to a prefix directory of the fragmented file and a number of the file fragment when a constructed keyword is a keyword of a fragmented file of the file.

11. The apparatus according to claim 9, wherein the computer-executable instructions stored in the memory further cause the processor to perform operations of:
acquiring a keyword corresponding to a to-be-read file when file content needs to be read;
acquiring metadata of the to-be-read file according to the keyword, and determining, according to the metadata, whether there is read permission; and
acquiring the to-be-read file according to the keyword when there is the read permission, so as to perform a read operation.

12. The apparatus according to claim 9, wherein the computer-executable instructions stored in the memory further cause the processor to perform operations of:
acquiring a keyword corresponding to the to-be-written file when data needs to be written into a file;
acquiring metadata of the to-be-written file according to the keyword;
determining, according to the metadata, whether there is write permission; and
acquiring the to-be-written file according to the keyword when there is the write permission so as to perform a write operation.

13. The apparatus according to claim 9, wherein the computer-executable instructions stored in the memory further cause the processor to perform operations of:
acquiring a keyword corresponding to the directory when a file in the same directory needs to be listed;
acquiring metadata of the directory according to the keyword, and determining, according to the metadata, whether there is permission to list the file in the directory; and
listing the file according to the keyword, wherein the file has a directory number corresponding to a prefix directory path is the same as the keyword of the directory when there is the permission to list the file in the directory.

14. The apparatus according to claim 9, wherein the computer-executable instructions stored in the memory further cause the processor to perform operations of:
acquiring a keyword corresponding to the to-be-renamed directory when a directory needs to be renamed;
acquiring metadata of the to-be-renamed directory according to the keyword, and determining, according to the metadata, whether there is permission to rename the to-be-renamed directory;
constructing and storing a mapping relationship between a directory number corresponding to an original directory and a directory obtained after the renaming when there is the permission to rename the to-be-renamed directory and after a rename operation is performed on the to-be-renamed directory, wherein the original directory is a directory before the rename operation is performed;
constructing and storing mapping relationships between directory paths, corresponding to a subdirectory and a nested subdirectory in the directory obtained after the renaming, and directory numbers of the subdirectory and the nested subdirectory; and
deleting a mapping relationship between the original directory and a directory number from the file system.

15. The apparatus according to claim 9, wherein the computer-executable instructions stored in the memory further cause the processor to perform operations of:
acquiring a keyword corresponding to the directory when path access permission for a directory needs to be changed;
acquiring metadata of the directory according to the keyword, and determining, according to the metadata, whether there is permission to change permission for the directory;
acquiring a keyword corresponding to a parent directory of the directory when there is the permission to change the permission for the directory;
acquiring path access permission information of the parent directory according to the keyword;
generating updated path access permission for the directory according to the path access permission information of the parent directory and updated directory access permission information, and updating directory path permission information in directory metadata corresponding to the directory; and
updating, according to the updated directory path permission information, path access permission information in directory metadata corresponding to a subdirectory and a nested subdirectory in the directory.

16. The apparatus according to claim 9, wherein the computer-executable instructions stored in the memory further cause the processor to perform operations of:
acquiring a keyword corresponding to a file when permission for the file needs to be changed;
acquiring, according to the keyword, file metadata corresponding to the file, and determining, according to the metadata, whether there is permission to change the permission for the file;
acquiring a keyword corresponding to a prefix directory of the file when there is the permission to change the permission for the file;
acquiring path access permission information of the prefix directory according to the keyword; and
generating updated path access permission for the file according to the path access permission information of the prefix directory and updated file access permission information, and updating file path access permission information in the file metadata corresponding to the file.
